(19) United States
(12) Patent Application Publication
(10) Pub. No.: US 2007/0244605 A1
(43) Pub. Date: Oct. 18, 2007

(54) Monitoring devices for use with ground treatment equipment

(76) Inventor: Mark Hopkins, Beaconsfield (CA)

Correspondence Address: MICHAEL BEST & FRIEDRICH LLP, 100 E WISCONSIN AVENUE, Suite 3300, MILWAUKEE, WI, 53202, US

(21) Appl. No.: 11/403,017

(22) Filed: Apr. 12, 2006

(51) Int. Cl. G05D 1/00

(52) U.S. Cl. 701/1; 701/93

(57) ABSTRACT

The present invention provides a monitoring device suitable for use with ground treatment equipment. The monitoring device comprises a sensor that is operative for obtaining data associated with movement of the ground treatment equipment and a processing unit that is communication with the sensor. The processing unit is operative for deriving speed information associated with the ground treatment equipment at least in part on the basis of the data obtained by the sensor, and for causing a user to be advised of this speed information.

### FIELD OF THE INVENTION

The present invention relates to the field of ground treatment equipment, and more particularly to monitoring devices suitable for monitoring operational characteristics of the ground treatment equipment, and for providing a user with information associated with the ground treatment equipment.

### BACKGROUND OF THE INVENTION

Ground treatment equipment, such as fertilizer distributors, seed distributors, pesticide distributors and lawn mowers are well known in the art. Such types of ground treatment equipment are commonly used on golf courses, and commercial or residential grounds, for performing landscaping and maintenance of the grounds.

A common problem associated with ground treatment equipment of the type described above, is that they must be operated at a relatively constant speed in order to perform their function properly. For example, in the case of granule distribution machines, such as fertilizer distributors, seed distributors and pesticide distributors, maintaining a constant speed is of critical importance. These machines typically use gravity to release their product from the hopper, and thus when the machine travels too quickly, not enough product gets distributed. Likewise, when the machine travels too slowly, too much product gets distributed. Given today's environmental awareness and sensitivity, it is important that not too much product gets distributed, since this can lead to leaching and contamination of sensitive ground areas. In addition, applying too little product can lead to ineffective results, thus defeat the purpose of applying the product altogether.

Similarly, in the case of lawn mowers, when the mower moves either too quickly or too slowly, the mower does not provide a good quality of cut to the grass. Therefore, it is also important for lawn mowers to move at a relatively constant speed in order to achieve the quality of cut required.

In light of this situation, a deficiency with existing manually operated ground treatment equipment, and certain motorized pieces of equipment, is that they do not provide any information to a user as to the speed of travel. It has been found that many users of equipment such as lawn mowers and granule distributors, vary their walking pace by up to 1 MPH over the course of operation. Given that the target speed for most types of ground treatment equipment is approximately 3 MPH, a variation of 1 MPH over the course of the application is significant. In general, it has been found that users will start off moving quite fast, and then slow their pace as they tire.

In addition, many of these types of ground treatment equipment rely only on a user's estimation as to the area of ground that has been treated. This means that the grounds manager has to either trust their employees estimation, or use complicated digital maps in order to assess the area of ground that has been treated.

In light of the above, it can be seen that there is a need in the industry for a monitoring device that is suitable for use with ground treatment equipment in order to alleviate, at least in part, the deficiencies of the prior art, and in order to improve on the overall efficiency and effectiveness of ground treatment equipment.

### SUMMARY OF THE INVENTION

In accordance with a first broad aspect, the present invention provides a monitoring device suitable for attachment to ground treatment equipment. The monitoring device comprises a sensor that is operative for obtaining data associated with movement of the ground treatment equipment and a processing unit that is in communication with the sensor. The processing unit is operative for determining the speed of the ground treatment equipment at least in part on the basis of the data obtained by the sensor, comparing the speed of the ground treatment equipment to a predetermined target speed and causing a user to be advised when the speed of the ground treatment equipment has deviated from the predetermined target speed.

In accordance with a second broad aspect, the present invention provides a method for monitoring the speed of ground treatment equipment. The method comprises receiving data associated with movement of the ground treatment equipment, determining at least in part on the basis of the data, the speed of the ground treatment equipment, comparing the speed of the ground treatment equipment to a predetermined target speed and causing a user to be advised when the speed of the ground treatment equipment has deviated from the predetermined target speed.

In accordance with another broad aspect, the present invention provides a granule distribution device that comprises a container for holding granules to be distributed on an area of land, at least one wheel, a sensor that is operative for obtaining data associated with movement of the granule distribution device, a processing unit in communication with the sensor and a information conveying unit. The processing unit is operative for determining the speed of the granule distribution device at least in part on the basis of the data obtained by the sensor and the information conveying unit is suitable for conveying to a user information associated with the speed of the granule distribution device.

In accordance with another broad aspect, the present invention provides a monitoring device suitable for use with ground treatment equipment. The ground treatment equipment is capable of acquiring a first state and a second state, wherein in the first state the ground treatment equipment is operative for treating the ground, and in the second state the ground treatment equipment is not operative for treating the ground. The monitoring device comprises a sensor for detecting when the ground treatment equipment is in the first state, and a computing unit that is operative for recording data associated with the speed of the ground treatment equipment while it is in the first state.

In accordance with another broad aspect, the present invention provides a monitoring device suitable for attachment to ground treatment equipment. The device comprises a sensor operative for obtaining data associated with the movement of the ground treatment equipment and a processing unit in communication with the sensor. The processing unit is operative for determining an area of ground treated by the ground treatment equipment at least in part on the basis of the data obtained by the sensor.

These and other aspects and features of the present invention will now become apparent to those of ordinary skill in the art upon review of the following description of specific embodiments of the invention and the accompanying drawings.

### BRIEF DESCRIPTION OF THE DRAWINGS

In the accompanying drawings:

FIG. 1 shows a first non-limiting example of a piece of ground treatment equipment that comprises a monitoring device in accordance with the present invention;

FIG. 2 shows a second non-limiting example of a piece of ground treatment equipment that comprises a monitoring device in accordance with the present invention;

FIG. 3A shows a block diagram of a monitoring device in accordance with a first non-limiting example of implementation of the present invention;

FIG. 3B shows a block diagram of a monitoring device in accordance with a second non-limiting example of implementation of the present invention;

FIG. 4 shows a non-limiting example of a method of monitoring speed as performed by the processing unit of the monitoring device of FIG. 3A;

FIG. 5A shows a first non-limiting example of an information conveying unit suitable for displaying information to a user;

FIG. 5B shows a second non-limiting example of an information conveying unit suitable for displaying information to a user;

FIG. 5C shows a third non-limiting example of an information conveying unit suitable for displaying information to a user.

Other aspects and features of the present invention will become apparent to those ordinarily skilled in the art upon review of the following description of specific embodiments of the invention in conjunction with the accompanying figures.

### DETAILED DESCRIPTION

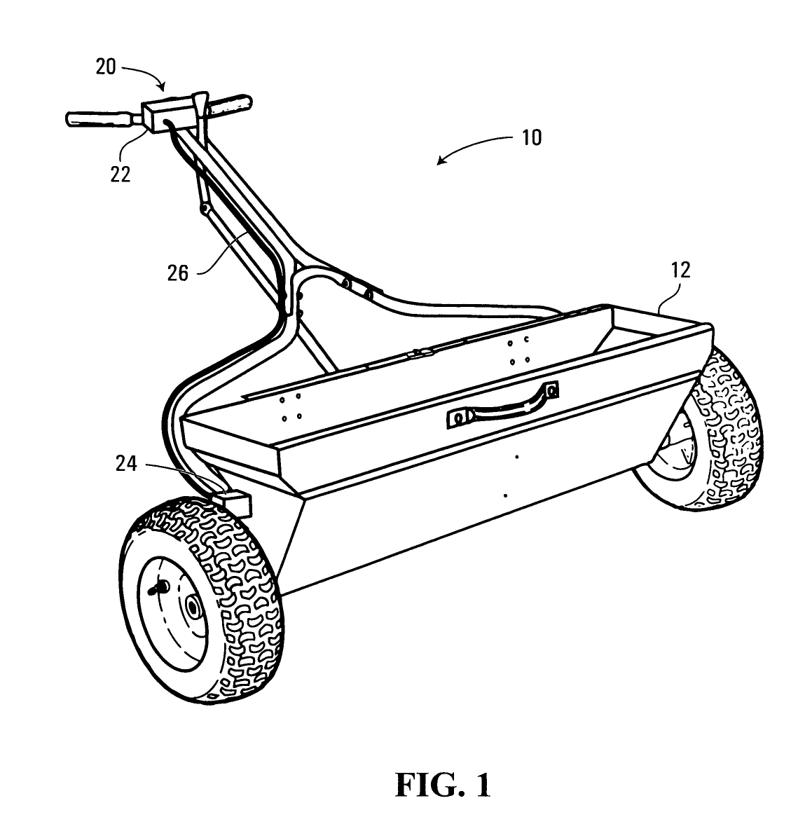

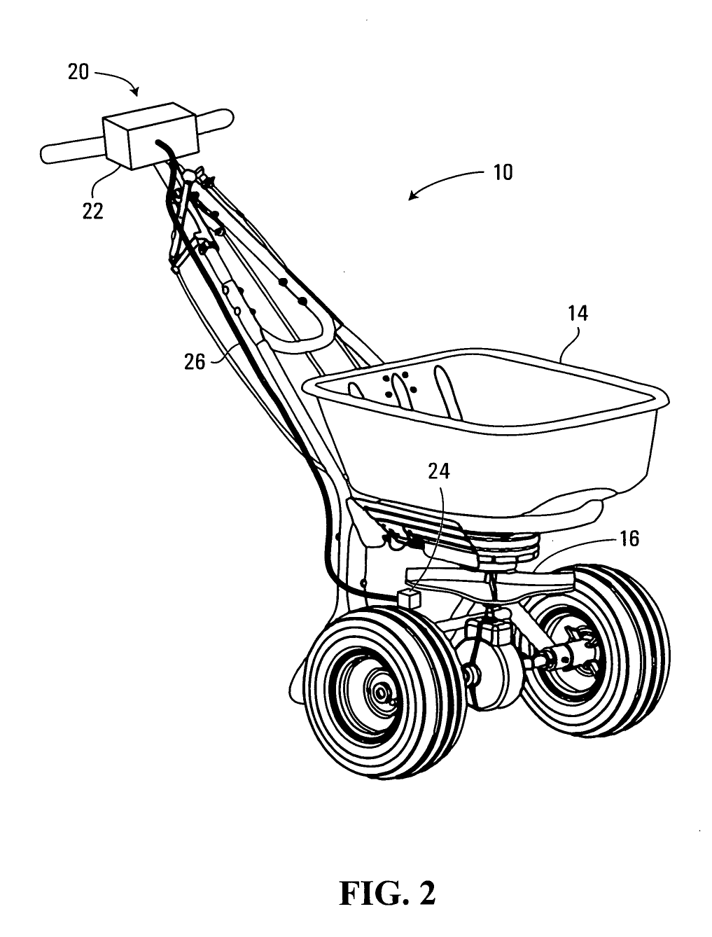

Shown in FIGS. 1 and 2, are two different types of ground treatment equipment 10 having attached thereto a monitoring device 20 in accordance with a non-limiting example of implementation of the present invention. The monitoring device 20 of the present invention is operative for providing information to a user associated with a characteristic of the ground treatment equipment. For example, the monitoring device 20 may be operative to provide information indicative of the current speed of the machine, whether the speed has deviated from a target speed, and/or the minimum, maximum or average speed of the machine over a period of time. In addition, the monitoring device 20 may also be operative to provide information associated with the operating condition of the machine. For example, in the case of a granule distribution device, the monitoring device 20 may provide information indicative of whether a hopper is opened or closed, and in the case of a lawn mower, the device 20 may provide information indicative of whether the cutting blades are engaged or not.

For the purposes of the present description, the term “ground treatment equipment” refers to any type of ground treatment equipment that requires a substantially constant forward speed in order to do its job effectively. For example, the ground treatment equipment may be a granule or liquid distributor, such as a seed or pesticide distributor, or a lawn mower, among other possibilities. The ground treatment equipment may be manually operated, suitable for attachment to a tractor, or motorised, without departing from the spirit of the invention.

In the example shown in FIG. 1, the ground treatment equipment 10 is in the form of a “drop-spreader” granule distribution device, and in the example shown in FIG. 2, the ground treatment equipment 10 is in the form of a “rotary-spreader” granule distribution device. Each of these two granule distribution devices is operative for distributing any one of fertilizer, seeds and/or pesticides, including herbicide, fungicide, insecticide, rodenticide, miticide, bacterial control and any other granule or liquid treatment products known in the art.

In the case of the “drop-spreader” granule distribution device shown in FIG. 1, the product to be distributed is contained in the hopper 12 and drops down through adjustable holes (not shown) in the base of the hopper 12 due to gravity. Therefore, for any given size of hole in the base of the hopper 12, the product will drop out at a substantially constant rate. It can thus be appreciated that depending on the speed at which distribution device is moved forward, a different amount of product is applied to the ground.

Likewise, in the case of the “rotary spreader” granule distribution device shown in FIG. 2, the product to be distributed is contained in the hopper 14 and, when in use, drops onto a rotating spreader 16 due to gravity. As the granule distribution device is moved forward, the rotating spreader 16 spins. The speed at which the rotating spreader 16 spins is controlled by the speed of the device. The faster the device is pushed, the faster the rotating spreader 16 spins. As such, depending on the speed at which the granule distribution device is moved forward, more or less product drops onto the rotary spreader 16, and the rotary spreader 16 spins at a different rate. As such, the faster the distribution device is moved forward, the less product lands on the rotary spreader 16 per unit time, and the farther the rotary spreader 16 will spray the product. This means that the faster the device is pushed, the less product will be applied to the ground that is being treated.

Although the ground treatment equipment 10 shown in FIGS. 1 and 2 are both manually operable granule distribution devices, as described above, it should be appreciated that the monitoring device 20 of the present invention can be attached to any type of ground treatment equipment 10 that should be moved at a substantially constant speed in order to do its job effectively.

As shown in FIGS. 1 and 2, the monitoring device 20 of the present invention comprises a computing unit 22 and a sensor 24. In the embodiment shown, the sensor 24 is operative for obtaining data associated with the movement of the ground treatment equipment, and as such is positioned towards the lower portion of the ground treatment equipment, in proximity to the wheels. The computing unit 22, which is operative for receiving and processing the data obtained by the sensor 24, is generally positioned in a region where it is easily accessible and visible to a user, such as near the handlebars, for example. The computing unit 22 and the sensor 24 can be mounted to the ground treatment equipment using bolts, snap fit devices or any other means known in the art.

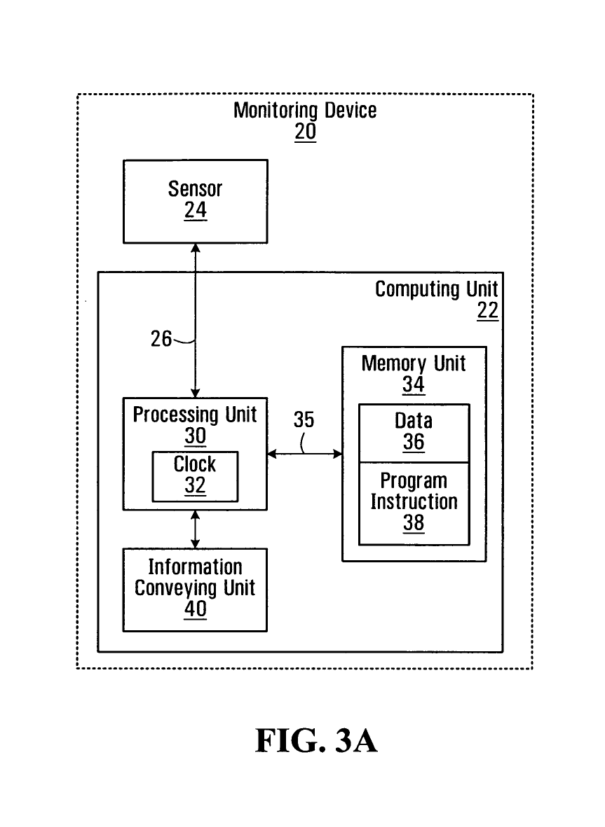

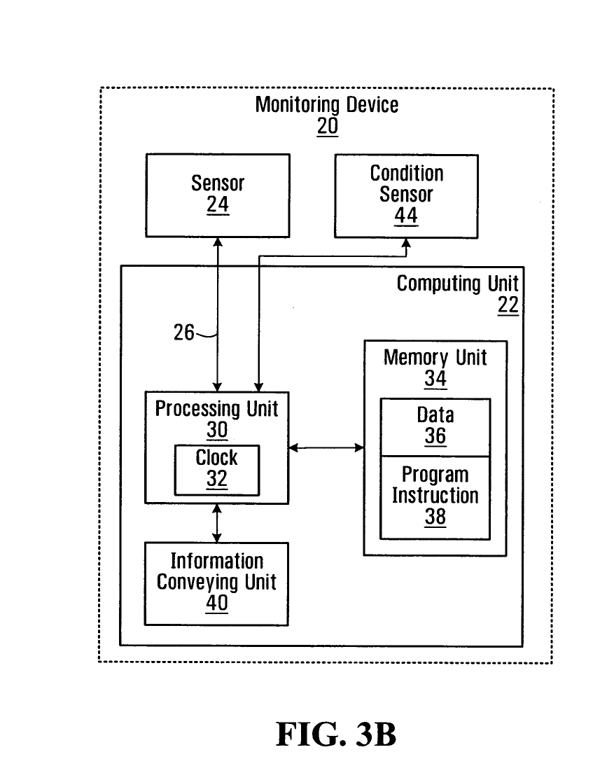

Shown in FIG. 3A is a non-limiting functional block diagram of the monitoring device 20 of the present invention. As shown, the computing unit 22 and the sensor 24 are connected to each other via a communication link 26. In the embodiment shown in FIGS. 1 and 2, the communication link 26 is a wireline link, however, it should be appreciated that the communication link 26 could also be a wireless link, such as an RF or infrared link, without departing from the spirit of the invention.

In accordance with the non-limiting embodiment shown, the computing unit 22 comprises a processing unit 30, a memory unit 34 and an information conveying unit 40. The processing unit 30 includes a clock 32. The processing unit 30 and the memory unit 34 are in communication with each other via a communication bus 35. The memory unit 34 includes data 36 and program instructions 38. The processing unit 30 is adapted to process the data 36 and the program instructions 38 in order to implement the functionality which will be described in more detail below.

As described above, the sensor 24 is operative for obtaining data associated with movement of the ground treatment equipment. The computing unit 22 is then operative for processing that data in order to provide information to a user. More specifically, the processing unit 30 is operative for processing the data in order to derive information to be conveyed to a user.

It should be appreciated that there are many types of sensors 24 that can be used to obtain data associated with the movement of the ground treatment equipment 10, all of which are included within the scope of the present invention.

In accordance with a first non-limiting example, the sensor 24 can be a magnetic sensor that is operative for detecting the rotation of the wheels. Such magnetic sensors generally comprise a magnetic detector that is operative for being affixed to the body of the ground treatment equipment, and a magnet that is operative for being attached to a wheel. The magnetic detector and the magnet are mounted to the ground treatment equipment such that each time the wheel makes a complete revolution, the magnet passes by the magnetic detector. For example, the magnet can be placed at any convenient location on the wheel rim. Each time the wheel makes a complete revolution, the magnet passes by the magnetic detector and the sensor 24 detects that a complete revolution has occurred. The sensor thus issues a signal to the computing unit 22 indicating that the wheel has made a complete revolution. Such magnetic sensors are well known in the art and will not be described in further detail herein.

In accordance with a second non-limiting example, the sensor 24 can be an optical sensor. Such optical sensors generally comprises a light detector that is affixed to the body of the ground treatment equipment 10, and a light emitting portion that is attached in proximity to the circumference of the wheel. Each time the wheel makes a complete revolution, the light emitting portion passes by the light detector, such that the sensor 24 detects that a complete revolution has occurred. The sensor 24 thus issues a signal to the computing unit 22 each time a complete revolution has occurred. Such optical sensors are known in the art and will not be described in further detail herein.

In accordance with a third non-limiting example, the sensor 24 can be a laser sensor that is able to determine the speed of the device by scanning the ground. In such a case the data obtained by the sensor 24 would be the actual speed of the ground treatment equipment, and not just a signal indicating a complete revolution of the wheel.

During use, the sensor 24 is operative for communicating the data associated with the movement of the ground treatment equipment 10 to the computing unit 22, and specifically to the processing unit 30. As mentioned above, that data could be simply a signal indicative that a wheel has made a complete revolution, or the data could actually be the speed at which the ground treatment equipment is travelling. Regardless of the type of data, the processing unit 30 is operative to process this data for generating information associated with the speed of the ground treatment equipment 10. This information could be at least one of the speed of the ground treatment equipment, whether the speed has deviated from a target speed, and/or the minimum, maximum or average speed of the ground treatment equipment over a period of time.

In the case where the data from the sensor 24 is indicative of a complete rotation of one of the wheels, such as in the case where the sensor is either a magnetic sensor or an optical sensor as described above, the processing unit 30 is operative for determining the speed of the ground treatment equipment according to the following formula:
Speed=distance/time

The distance that has been travelled is determined based on the signals received from the sensor 24. By knowing the circumference of the wheel on which the sensor 24 is mounted, each time the sensor 24 issues a signal to the processing unit 30, the processing unit 30 knows that the ground treatment equipment has travelled the distance equivalent to the circumference of the wheel. Data indicative of the circumference of the wheel can be stored in the data 36 section of the memory unit 34, such that it can be accessed by the processing unit 34 when needed. The manner in which data is stored in the memory unit 34 will be described in more detail further on in the description.

During the time period in which the sensor 24 is issuing signals to the computing unit 22, the clock 32 measures the time it takes for the wheel to make a complete revolution (i.e. the time between signals received from the sensor 24). Once the processing unit 30 knows both the distance being travelled, and the time taken to travel that distance, the processing unit 30 can then determine the speed of the ground treatment equipment using the above formula.

Once the processing unit 30 has determined the speed of the ground treatment equipment, additional information such as a deviation from a target speed, or the minimum and maximum speed that the ground equipment 10 has travelled can be determined. The processing unit can then cause the information conveying unit 40 to convey information associated with the speed of the ground treatment equipment to the user. As will be described in more detail further on, the information conveying unit 40 can be any one of speakers, screens, dials, lights, or any other means known in the art for conveying information to a user.

As mentioned above, in accordance with a non-limiting example of implementation, the processing unit 30 is operative for determining whether the speed of the ground treatment equipment 10 has deviated from a target speed. As described in the background of the present application, most types of ground treatment equipment have a target operational speed at which they work best, and provide the most effective results. Given that most users of ground treatment equipment vary their pace during the course of use, it is desirable that the users can be advised if their speed deviates from a target speed.

It should be appreciated that the target speed may be a specific value, such as 3 MPH, or alternatively, the target speed may be a range of values, such as 2.8-3.2 MPH, for example. As will be described in more detail below, the target speed may be stored in the memory unit 34. This value may either be pre-programmed into the monitoring device 20 by a manufacturer, or may be entered into the device by a user of the ground treatment equipment prior to use.

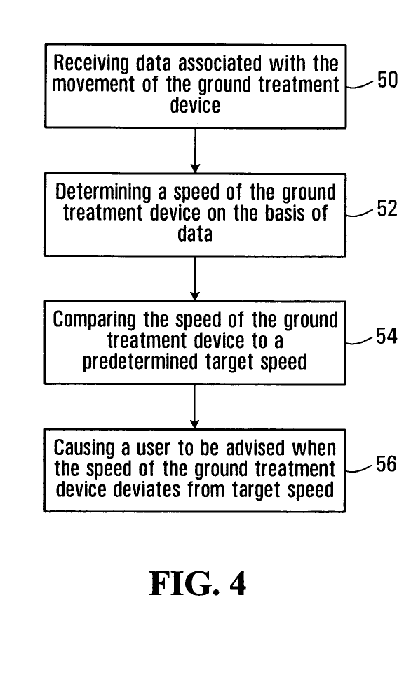

Shown in FIG. 4 is a non-limiting example of a process performed by the processing unit 30 for determining whether the speed of the ground treatment equipment has deviated from a target speed. Firstly, at step 50, the processing unit 30 receives data associated with the movement of the ground treatment equipment 10 from the sensor 24. At step 52, the processing unit determines the speed of the ground treatment equipment on the basis of the information received at step 50. The speed of the ground treatment equipment can be determined in the manner described above; namely by dividing the distance travelled by the time taken to travel that distance. Then at step 54, the processing unit 30 compares the speed to a predetermined target speed, in order to determine if the speed of the ground treatment equipment 10 has deviated from the predetermined target speed. As described above, the predetermined target speed can be stored in the memory unit 34 of the computing unit 22.

In the case where the speed has deviated from the target speed, at step 56, the processing unit 30 causes the information conveying unit 40 to advise the user that the speed of the ground treatment equipment has deviated from the target speed. In response to this warning, the user can then adjust his or her operating speed.

In yet a further example of implementation, the computing unit 22 is also operative to determine the area of ground treated by the ground treatment equipment 10. This is determined in accordance with the following formula:
Area treated=distance travelled while in an operational state*pass width

The distance travelled while in the operational state refers to the distance travelled by the ground treatment equipment 10 while the ground treatment equipment is actually treating the ground. For example, depending on the type of ground treatment equipment that is being used, the operational state may be when the equipment is spreading granules, or when it is cutting grass. It should be appreciated that the distance travelled while the ground treatment equipment is moving from a storage area to the portion of ground that will be treated is not included in the calculation of the area treated. As will be described in more detail below, the ground treatment equipment may include a condition sensor 44 that is operative to determine when the ground treatment equipment 10 is in an operational state (i.e when a hopper is open, or when the blades are engaged and rotating).

The computing unit 22 is operative to determine that the ground treatment equipment is in an operational state upon receipt of a signal from the condition sensor 44 or on the basis of an input from a user of the ground treatment equipment 10. Upon detection that the ground treatment equipment 10 is an operational condition, the computing unit 22 computes the area of ground treated.

The distance travelled while in the operational state can be determined on the basis of the data received from the sensor 24. For example, in the case where the sensor 24 is a magnetic sensor, or an optical sensor as described above, the distance is determined by multiplying the number of complete revolutions of the wheel by the circumference of the wheel. The pass width is defined as the distance between passes made by the ground treatment equipment. In the case of manual granular distribution machines, the path width is often in the order of 10 ft. The path width can be stored in the memory unit 34 of the computing unit 22. As such, by multiplying the distance travelled by the pass width, the processing unit 30 can determine the area of ground treated. The area of ground treated can be computed at the end of using the ground treatment equipment and then conveyed to a user at that time, or alternatively, the area of ground treated can be computed continuously throughout the ground treatment application and continuously conveyed to a user.

As described above, once the processing unit 30 has determined the information such as the speed of the device, a deviation from a target speed and/or the area of ground treated, the processing unit 30 issues one or more signals to the information conveying unit 40, such that the information derived by the processing unit 30 can be conveyed to a user.

The information conveying unit 40 can be any type of device that is able to convey information to a user. In accordance with a first non-limiting example, the information conveying unit 40 can be one or more speakers that provide the user with an audio indication of the information derived by the processing unit 30. For example, in order to convey information indicative of the speed of the ground monitoring machine 10 or the area of ground treated a synthesised voice, or a pre-recorded voice, can be broadcast from the speakers, in order to read out this information. In a further example, the speakers may simply broadcast a beeping sound in order to alert the user that the speed of the ground treatment equipment has deviated from a target speed. As such, in response to the beeping sound, the user can speed up, or slow down his/her pace.

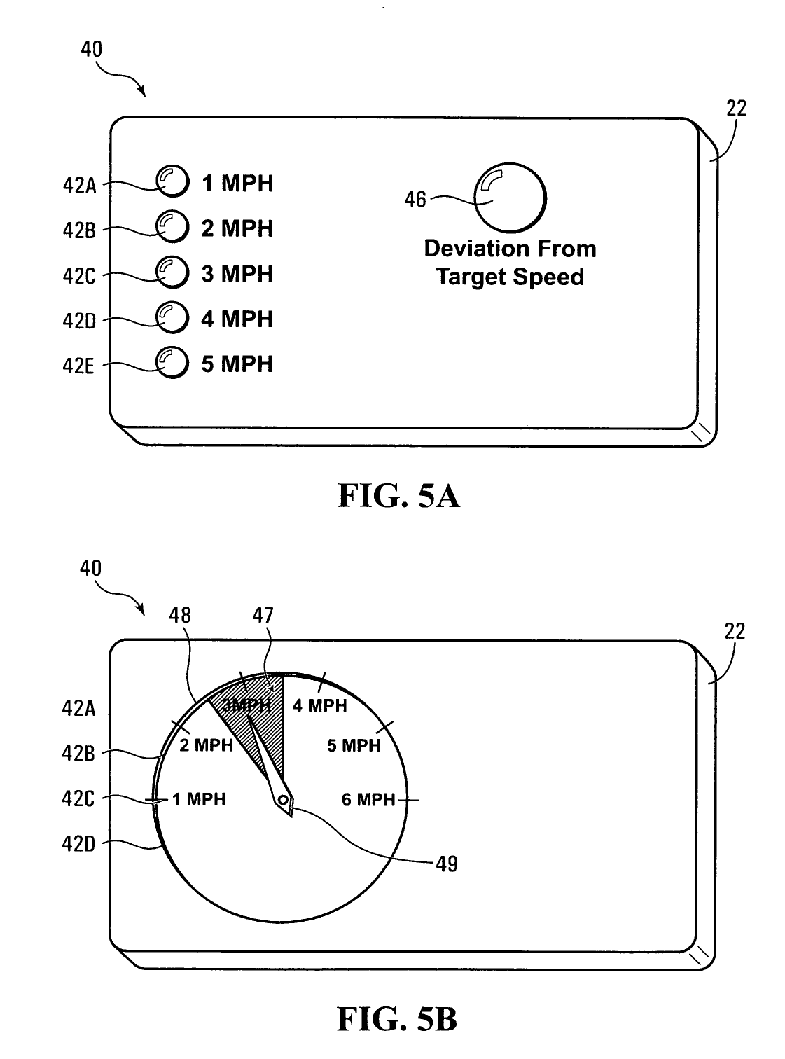

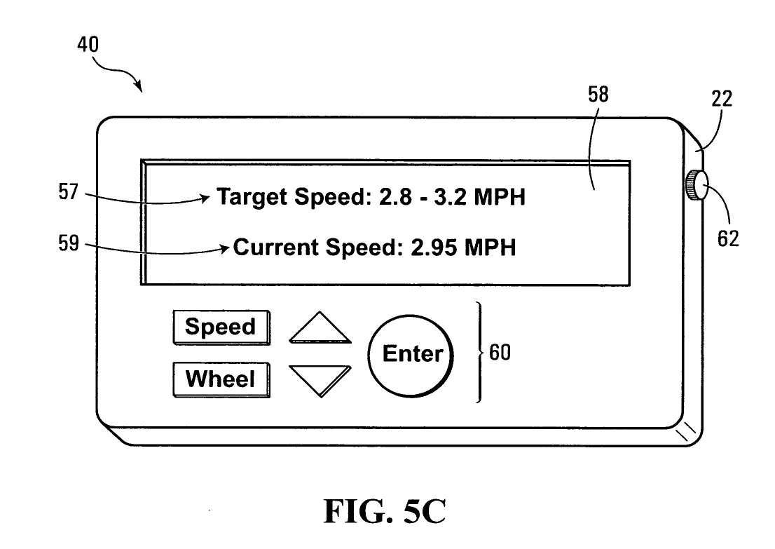

In accordance with a second non-limiting example, the information conveying unit 40 can be lights, dials, screens, or any other type of device that is operative to provide a user with a visual indication of the information derived by the processing unit 30. Shown in FIGS. 5A-5C are some non limiting examples of information conveying units 40 that are operative for conveying visual information to a user.

Shown in FIG. 5A is an information conveying unit 40 that includes a plurality of lights 42a-e and 46. Each of the lights 42a-e is associated with a respective speed that is identified next to the light. As such, in order to convey to the user the speed of the ground treatment equipment 10, one of the lights 42a-e lights up. For example, in the case where the ground treatment equipment is travelling 4 MPH, light 42d would be lit up. In the example of implementation shown, the information conveying unit further includes a light 46 that is operative for being lit up when the speed of the ground treatment equipment 10 deviates from a target speed. As such, when light 46 lights up, a user will know that the speed of the ground treatment equipment 10 has deviated from the target speed, and by looking at the speed displayed by lights 42a-e, the user will know whether to speed up or slow down. Alternatively, the light 46 could light up with a different color depending on whether the user should speed up or slow down.

Shown in FIG. 5B is an information conveying unit 40 that includes a dial 48. The dial 48 includes an indication of a variety of speeds and a pointer 49 that is operative to move during the course of operation of the ground treatment equipment in order to point to the speed of travel. In a non-limiting example, the dial may include a shaded portion 47 that indicates the target speed of the machine. As such, when the pointer 49 is positioned within this shaded region, the user knows that the ground treatment equipment is travelling within the target speed. In the case where the dial 48 is a digital dial, the shaded region may be changed depending on the target speed of the particular ground treatment equipment being used.

Shown in FIG. 5C is an information conveying unit 40 that includes a display screen 58. The display screen 58 is operative for displaying the information derived by the processing unit 30. In the example shown, the display screen 58 is displaying information indicative of the target speed at line 57, and information indicative of the current speed of the ground treatment equipment at line 59. It should be understood that the display screen 58 could also display information indicative of the area of ground treated, or any other information derived by the processing unit 30. In addition, it should be understood that the information may be displayed to the user via the display screen 58 in any manner conceivable, via text, symbols, diagrams, etc. . . . For example, the screen 58 may simply indicate the current speed of the ground treatment equipment, until the ground treatment equipment exceeds, or falls below the target speed. At that point, the screen may flash a big message reading “You have deviated from the target speed” and “you should speed up” or “you should slow down” depending on the situation.

In the embodiments described above, and shown in FIGS. 3A and 5A-5C, the information conveying units 40 are shown as being part of the computing units 22. It should, however, be understood that the information conveying units 40 could be separately located from the computing units 22. For example, the computing unit 22 and the information conveying unit 40 may be contained in separate physical entities, that are located at different positions on the ground treatment equipment 10. More specifically, the computing unit 22 may be located in closer proximity to the sensor 24, and the information conveying unit 40 may be located in an easily accessible and visible position to the user, such as near the handlebars, for example. In such a case the computing unit 22 and the information conveying unit would be in communication with one another via either a wireline link or a wireless link.

As described above, the computing unit 22 is operative to store the values such as the wheel circumference, the target speed and a path width, in the memory unit 34. In a first non-limiting example, these values are programmed into the memory unit 34 by the manufacturer of the monitoring device 20. In such a case, any given monitoring device 20 will only be suitable for use on ground treatment equipment having the values programmed into the memory unit 34. For example, if the value of the wheel circumference that has been programmed into the memory unit 34 is 12″, then that particular monitoring device 20 will only be able to provide accurate speed information for ground treatment equipment 10 having wheels with a 12″ diameter.

In a second non-limiting embodiment, the monitoring device 20 can be configured by a user prior to use, such that it is the user who enters the values, such as wheel circumference, target speed and/or pass width, into the monitoring device 20. By allowing the user to configure the monitoring device 20 prior to use, the monitoring device 20 can be used with multiple different types of ground treatment equipment, thus making the monitoring device 20 far more versatile.

There are a variety of different ways for a user to configure the monitoring device 20 of the present invention. In accordance with a first non-limiting example of implementation, the information conveying unit 40 of the monitoring device includes one or more user operable inputs 60, as shown in FIG. 5C. The user can thus use these user operable inputs 60 in order to enter information into the memory unit 34 of the monitoring device 20. In the non-limiting embodiment shown in FIG. 5C, the user operable inputs 60 are in the form of buttons, however any other type of user operable inputs, such as a mouse, dials, levers, a keypad, a touch-sensitive screen or a voice recognition device, could also be used without departing from the spirit of the invention.

In an alternative non-limiting example of implementation, the monitoring device 20 includes an input/output port 62, such as a USB port or an infra-red port, for receiving configuration information from an external device. The external device may be a PC, a PDA, a cell phone, or any other device that is suitable for transferring information to the monitoring device 20. In order to configure the monitoring device 20, a user would connect the monitoring device 20 to the external device via the input/output port 62, in order to transfer from the external device to the monitoring device 20 information such as wheel circumference, target speed and/or pass width.

In accordance with a non-limiting example of implementation, in addition to determining information associated with speed, the monitoring device 20 is further operative for determining an operational condition of the ground treatment equipment 20. Examples of such operational conditions include whether the opening to a hopper is open or closed, and whether the cutting blades of a lawn mower are engaged. Shown in FIG. 3B is a functional block diagram of a monitoring device 20 that includes a condition sensor 44. It is the condition sensor 44 that is operative for detecting an operational condition of the ground treatment equipment 10.

In the case of a granule distribution device, such as those shown in FIGS. 1 and 2, the condition sensor 44 can be operative to detect whether the holes at the base of the hopper are in an open or closed position. Such condition sensors 44 can be optical sensors or magnetic sensors, such as those described earlier in the application. The condition sensors 44 are generally separate from the computing unit 22, and are in communication with the computing unit 22 via either one of a wireline link or a wireless link.

In the case of a granule distribution device, once the sensor 44 detects that the holes to the hopper are in an open position, the sensor 44 sends a signal to the processing unit 30. The processing unit 30 then issues a signal to the information conveying unit 40, for causing the user to be advised that the holes to the hopper are in the open position. Such an indication can be either an audio indication or a visual indication, as described above. By advising the user when the hopper is open, unnecessary spills and wastage can be avoided.

In the case of a lawn mower, the condition sensor 44 is operative for detecting when the cutting blades are engaged. In the case of most lawn mowers for golf courses and commercial landscaping purposes, the cutting blades often have two positions, namely a retracted position, wherein the blades are retracted from a cutting position, and a cutting position wherein the blades are lowered to a level where they are suitable for cutting grass. When the blades are in the cutting position, they can be in either an engaged state, wherein they are powered so as to be able to cut the grass, or an un-engaged state wherein the blades simply skim the ground. When the lawn mower is travelling between cutting sites, or between a storage garage and a cutting site, the blades are generally positioned in the retracted, un-engaged position, so as to prevent wear on the blades during travel. In the case where the lawn mower is only travelling a short distance, the blades may be in the cutting position, but un-engaged, such that they just skim the ground. Finally, once the operator has travelled to the cutting site, the blades are engaged, such that they are powered by the engine and can cut the grass.

In general, in order to engage the blades, either a solenoid allows the hydraulic motors to operate, an electric clutch is connected to the hydraulic pump or an electric or a lever clutch on a power take off (PTO) operates the belts in a belt driven system. In the case of walking mowers, a manual lever can be activated after transporting the mower to the cutting site, in order to engage the blades.

Once the condition sensor 44 detects that the blades have been engaged, the sensor 44 issues a signal to the processing unit 30. The processing unit 30 can then issue a signal to the information conveying unit 40, for causing the user to be advised that the blades are in the engaged position. Such an indication can be either an audio indication or a visual indication, as described above. By advising the user when the blades are in the engaged position, it prevents the user of the lawn mower from travelling unnecessary lengths, or at inappropriate speeds, while the blades are in the cutting state.

Condition sensors 44 for detecting whether the blades are in the engaged position or the un-engaged position can be integral sensors to the lawn mower. Alternatively, additional sensors can be added to the lawn mower for detecting the positioning of the blades. Such sensors are known in the art, and as such will not be described herein.

The monitoring device 20 may also be operative for recording information in the memory unit 34.

In accordance with a non-limiting example, the processing unit 30 may be operative to store speed information associate with the ground treatment equipment in the memory unit 34. As described above, the processing unit 30 is operative for determining the speed of the ground treatment equipment 10 while the ground treatment device is in use. Therefore, in addition to deriving this information, the processing unit can also cause this information to be stored in the memory unit 34. The speed information can automatically be recorded in the memory unit 34 whenever the ground treatment equipment moves forward, or alternatively the speed information can start to be recorded in response to a certain event. For example, the certain event may be a signal from the sensor 44 indicative that the holes of the hopper are open, or that the blades of the mower are in an engaged position. Alternatively, the monitoring device 20 may include a user input that can be activated by a user when the user wants the speed information to be recorded.

By causing the recording to start on the basis of a triggering event, the processing unit 30 may not start recording the speed information until it has detected that the ground treatment equipment is in a treatment state. For example, in the case of a granule distribution device, the treatment state would be when the holes in the hopper are in the open position, and in the case of a lawn mower, the treatment state would be when the cutting blades are engaged for cutting. In this manner, it only records speed information necessary to determine whether the treatment process was performed properly. In other words, it may not be necessary to record speed information when the ground treatment equipment is travelling from a garage to a treatment site.

The information stored in the memory unit 34 can be used to generate statistical information such as the maximum speed of travel, the minimum speed of travel, the average speed of travel, etc. . . .

As described above, for many types of ground treatment equipment, it is important that the machine moves at a fairly constant speed. Therefore, by recording the speed information for later review, a grounds keeper or landscape manager can then check the memory of the monitoring device 20 in order to ensure that the ground treatment equipment has been operated at the correct speed. For example, by verifying that the average speed of the machine during treatment state is within the target speed, it can be determined that the ground treatment equipment was operated properly.

The information that can be derived from the recorded information can be retrieved in a variety of different ways. In accordance with a first non-limiting example, the information such as maximum speed, minimum speed and average speed can be conveyed to the user via the information conveying unit 40, such as on a display screen 58 for example. The information can be retrieved by manipulating the user operable inputs 60 so as to retrieve the stored information.

In yet a further non-limiting example, the information can be downloaded from the computing unit 22 to an external device such as a PC, a PDA or a cell phone, among other possibilities. In this manner, when the ground treatment operation has been completed, the user of the machine, or a more senior grounds keeper, can attach an external device to the monitoring device 22, and download the information stored in the memory unit 34. This can be useful for record keeping purposes.

In an alternative embodiment, instead of recording the speed information to the memory-device 34, this information can be recorded to an external memory device such as a memory card, memory wand, CD, etc that connected to the computing unit 22.

As described above, the monitoring device 20 of the present invention is a separate component from the ground treatment equipment. As such, the combination of the sensor 24 and the computing unit 22 (and optionally the sensor 44) can be sold as a kit that can be attached to ground treatment equipment that are sold separately. In this manner, the monitoring device 20 can be retrofitted to existing ground treatment equipment.

In accordance with a non-limiting example of implementation, the monitoring device 20 is powered via one or more batteries. In a preferred embodiment, the monitoring device 20 is powered via lithium batteries, however, it should be appreciated that any other power source could be used without departing from the spirit of the invention.

In an alternative embodiment, the functionality of the sensor 24 and the computing unit 22, as described above, could be included in newer generations of ground treatment equipment. More specifically, the functionality of the sensor 24 and the computing unit 22 would be built into the ground treatment equipment, such that they are integral components of the ground treatment equipment.

Although the present invention has been described in considerable detail with reference to certain preferred embodiments thereof, variations and refinements are possible without departing from the spirit of the invention. Therefore, the scope of the invention should be limited only by the appended claims and their equivalents.

1. A monitoring device suitable for attachment to ground treatment equipment, said monitoring device comprising:
a sensor operative for obtaining data associated with movement of the ground treatment equipment;
a processing unit in communication with said sensor, said processing unit being operative for:
i) determining the speed of the ground treatment equipment at least in part on the basis of the data obtained by said sensor;
ii) comparing the speed of the ground treatment equipment to a predetermined target speed;
iii) causing a user to be advised when the speed of the ground treatment equipment has deviated from said predetermined target speed.

2. A monitoring device as defined in claim 1, wherein the ground treatment equipment is manually operable.

3. A monitoring device as defined in claim 1, wherein said predetermined target speed includes a range of speeds.

4. A monitoring device as defined in claim 3, wherein said processing unit is in communication with a memory unit, said predetermined target speed being stored in said memory unit.

5. A monitoring device as defined in claim 4, wherein said predetermined target speed is entered into said memory by a user of the ground treatment equipment.

6. A monitoring device as defined in claim 3, wherein said sensor is a magnetic sensor, adapted for detecting a complete rotation of at least one wheel of the ground treatment equipment.

7. A monitoring device as defined in claim 3, wherein said sensor is an optical sensor, adapted for detecting a complete rotation of at least one wheel of the ground treatment equipment.

8. A monitoring device as defined in claim 1, wherein a user of the ground treatment equipment is advised that the speed of the ground treatment equipment has deviated from said predetermined target speed via at least one of an audio indication and a visual indication.

9. A monitoring device as defined in claim 8, further comprising speakers suitable for providing a user with an audio indication that the speed of the ground treatment equipment has deviated from said predetermined target speed.

10. A monitoring device as defined in claim 8, further comprising a display suitable for providing a user with a visual indication that the speed of the ground treatment equipment has deviated from said predetermined target speed.

11. A monitoring device as defined in claim 1, wherein the ground treatment device is a granule distribution device that includes a hopper for holding the granules to be distributed, and wherein said sensor is a first sensor, said speed monitoring device further comprising a second sensor suitable for detecting when the hopper is open.

12. A monitoring device as defined in claim 1, wherein said processing unit is operative for determining an area of ground that has been treated by the ground treatment equipment at least in part on the basis of a distance that has been covered and a pass width.

13. A monitoring device as defined in claim 1, further comprising an input/output port for enabling information to be uploaded to said monitoring device and downloaded from said monitoring device.

14. A method for monitoring the speed of a ground treatment equipment, said method comprising:
receiving data associated with a movement of the ground treatment equipment;
determining at least in part on the basis of said data, the speed of the ground treatment equipment;
comparing the speed of the ground treatment equipment to a predetermined target speed;
causing a user to be advised when the speed of the ground treatment equipment has deviated from said predetermined target speed.

15. A granule distribution device, comprising:
a container for holding granule to be distributed;
at least one wheel;
a sensor operative for obtaining data associated with movement of the granule distribution device;
a processing unit in communication with said sensor, said processing unit being operative for determining the speed of the granule distribution device at least in part on the basis of the data obtained by said sensor;
an information conveying unit suitable for conveying to a user of the granule distribution device information associated with the speed of the granule distribution device.

16. A granule distribution device as defined in claim 15, wherein said processing unit is operative for determining if the speed of the granule distribution device has deviated from a target speed.

17. A granule distribution device as defined in claim 16, wherein said predetermined target speed includes a range of target speeds.

18. A granule distribution device as defined in claim 15, wherein said information conveying unit comprises a display screen suitable for displaying to a user information indicative of the speed of the granule distribution device.

19. A monitoring device suitable for use with ground treatment equipment, the ground treatment equipment being capable of acquiring a first state and a second state, wherein in the first state the ground treatment equipment is operative for treating the ground, and in the second state the ground treatment equipment is not operative for treating the ground, said monitoring device comprising:
a sensor for detecting when the ground treatment equipment is in the first state; and
a computing unit operative for recording data associated with the speed of the ground treatment equipment while the ground treatment equipment is in the first state.

20. A monitoring device as defined in claim 19, wherein said monitoring device further comprises a information conveying unit suitable for displaying information associated with the speed of the ground treatment equipment.

21. A monitoring device as defined in claim 20, wherein said information associated with the speed of the ground treatment equipment includes at least one of an average speed, a maximum speed and a minimum speed.

22. A monitoring device as defined in claim 21, further comprising an input/output port suitable for connecting to an external device.

23. A monitoring device as defined in claim 22, wherein said input/output port is operative for receiving configuration information from the external device.

24. A monitoring device as defined in claim 22, wherein information stored in said computing unit can be downloaded to an external device via said input/output port.

25. A monitoring device as defined in claim 22, wherein said input/output port includes at least one of an infrared port and a USB port.

26. A monitoring device as defined in claim 19, wherein the ground treatment equipment is a grass mower having cutting blades suitable for acquiring an engaged position and an un-engaged position, wherein when the grass mower is in the first operational state, the cutting blades are in the engaged position.

27. A monitoring device as defined in claim 19, wherein the ground treatment equipment is a granule distribution machine having a hopper for holding granule to be distributed, the hopper having holes through which the granule is released, wherein when the granule distribution machine is in the first operational state, the holes in the hopper are in an open position.

28. A monitoring device suitable for attachment to ground treatment equipment, said device comprising:
a sensor operative for obtaining data associated with the movement of the ground treatment equipment;
a processing unit in communication with said sensor, said processing unit being operative for determining an area of ground treated by the ground treatment equipment at least in part on the basis of the data obtained by the sensor.

29. A monitoring device as defined in claim 28, wherein the ground treatment equipment is a manually operable device.

30. A monitoring device as defined in claim 28, wherein the sensor is a first sensor, the monitoring device further comprising a second sensor, the ground treatment equipment being capable of acquiring a first state and a second state, wherein in the first state the ground treatment equipment is operative for treating the ground, and in the second state the ground treatment equipment is not operative for treating the ground, said second sensor being operative for detecting when the ground treatment equipment is in the first state.
